(19) United States
(12) Patent Application Publication
(10) Pub. No.: US 2007/0151393 A1
(43) Pub. Date: Jul. 5, 2007

(54) CABLE-OPERATED RETRACTABLE SPRING PIN ASSEMBLY

(75) Inventors: Ronald W. Phillips II, Akron, OH (US); Ronald S. Dise, Perkasie, PA (US)

Correspondence Address: GREGORY J. GORE, 70 WEST OAKLAND AVENUE, SUITE 316, DOYLESTOWN, PA, 18901, US

(73) Assignee: PEM MANAGEMENT, INC., Wilmington, DE (US)

(21) Appl. No.: 11/567,483

(22) Filed: Dec. 6, 2006

Related U.S. Application Data
(60) Provisional application No. 60/597,549, filed on Dec. 8, 2005.

(51) Int. Cl. F16C 1/10

(52) U.S. Cl. 74/500.5

(57) ABSTRACT

A unified spring pin assembly provides remote actuation of a spring pin by pulling a cable. The assembly includes a retainer with an apertured cap at the top which is attached by clinch deformation. Clinch means also joins a retainer of the spring pin sub-assembly to a sheet. A spring operates between the inside surface of the cap and the pin. The pin includes a bore which extends through its entire length to provide a passage for the cable which includes a ball end that pushes against the end of the pin when the cable is pulled.

### RELATED APPLICATION

This patent application is related to provisional patent application Ser. No. 60/597,549 entitled “Cable-Operated Retractable Spring Pin Assembly” filed on Dec. 8, 2005, priority from which is hereby claimed.

### FIELD OF THE INVENTION

The present invention relates to a cable-operated spring pin assembly. More specifically, it relates to a spring pin assembly which may be permanently attached to a sheet yet provide for the removal and replacement of the cable without disassembly or without need for removing the assembly from the sheet.

### BACKGROUND OF THE INVENTION

Spring-loaded pin assemblies for remote actuation by a cable or pull cord are well-known. The basic components of these assemblies include a housing and a spring-biased pin. A cable or pull cord is affixed to the pin and pulls the pin against the restorative force of the spring. In many applications there is a need for a spring pin assembly which can be easily and permanently joined to a sheet and which provides the above-described advantage of replacement of the actuating cable without the need for disassembly. There is therefore a need in the art for such a device.

### SUMMARY OF THE INVENTION

A unified spring pin assembly of the invention provides remote actuation of a spring pin by pulling a cable. The invention utilizes clinch technology to assemble and then later join the spring pin sub-assembly to a sheet as a unit. The pull cord or cable is then later inserted into a bore which passes through the sub-assembly, thus negating the need for disassembly of the spring pin component or its removal from the sheet for installation or removal of the cable. This simplifies the user's BOM and assembly operations by reducing the number of parts, eliminating loose hardware, and easing maintenance.

More specifically, the applicants have devised a spring pin component which includes a retainer barrel with a mouth at the top and clinch means at the bottom. A bore for receiving a sliding spring pin passes through the entire length of the retainer. A narrowed portion of the retainer bore at the bottom creates an internal step which provides a stop that captivates the spring pin in the extended direction. The internal stop in the barrel of the retainer abuts a compatible step on the exterior surface of the pin.

At the top of the retainer is an apertured cap which is permanantly clinched into the top surface of the retainer barrel in flush attachment therewith. A spring operates between the inside surface of the cap and the pin. In order to better accommodate the spring and to extend the stroke of the pin, the pin includes an enlarged portion at the top of the internal bore having an upward-facing internal flange which abuts the end of the spring. The bore of the pin extends through its entire length and therefore a passage for a cable is provided through the entire assembly.

The pin further includes a narrowed portion of its bore at a mid-section thereof. This configuration provides a second downward-facing internal flange of the pin which cooperates in mechanical interference with an enlarged portion of the end of the cable. The structures of the pin are preferably cylindrical in nature and the enlarged end of the cable is preferably a ball end.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a bottom front isometric view of the invention.

FIG. 2 is a partial sectional elevation view thereof.

### DESCRIPTION OF THE PREFERRED EMBODIMENT

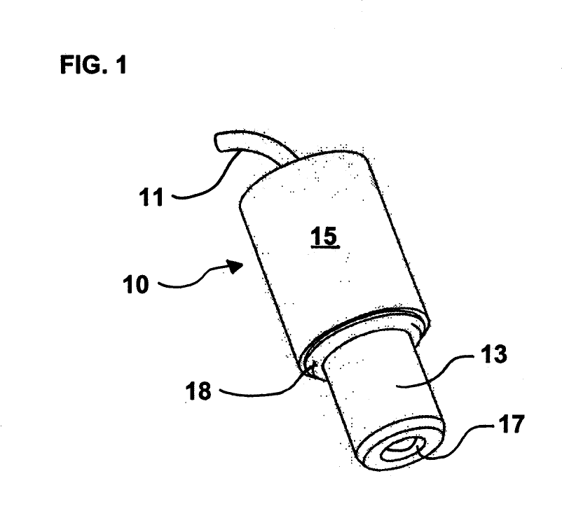

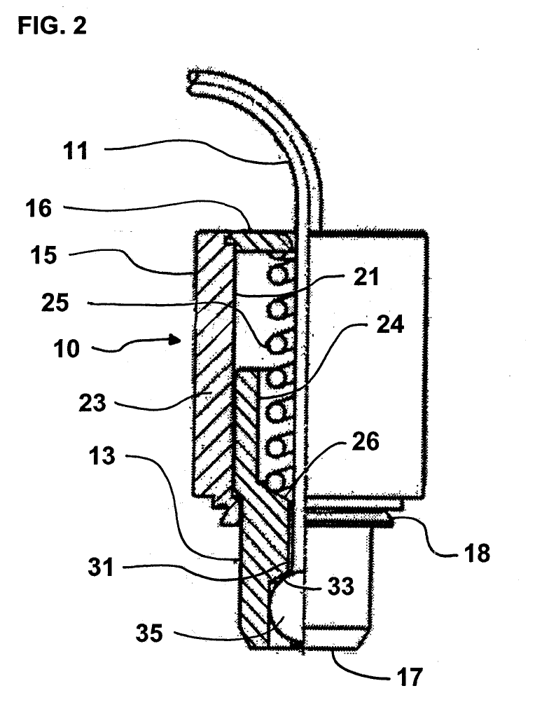

Referring now to FIG. 1, a spring pin assembly 10 of the present invention is comprised of a retainer 15 with clinch means at the bottom and a through-bore which receives a pin 13 in sliding engagement with the retainer. Pin 13 also includes a through-bore with an open mouth 17 at the bottom. Actuator cable 11 is inserted into mouth 17 exiting the top of the assembly 10 as will be shown in greater detail with regard to FIG. 2.

Referring now to FIG. 2, cable 11 operates on spring pin sub-assembly component 10 to retract pin 13 which is slidable within retainer 15. Cable 11 is inserted into the sub-assembly 10 by first passing it through an open mouth 17 at the bottom and then passing it up through the hollow center of the sub-assembly, finally exiting through an aperture in the cap 16 which is affixed to the top of the retainer. Clinch means 18 at the base of the retainer rigidly secures the assembly to an apertured sheet (not shown).

The retainer includes a counterbore 21 which is closely dimensioned to a slide portion 23 at the upper end of the pin which bears against the inside wall of the retainer counterbore 21 as the pin extends and retracts. A spring 25 operates between the inside surface of cap 16 and a spring counterbore end face 26 at the opposite end of the spring. Pin counterbore 24 receives the spring to provide for a longer spring and a longer stroke of the pin. The pin 13 includes a narrowed portion 31 of a bore therethrough which closely receives the outer diameter of cable 11. A downward-facing step 33 is formed in the bore of the pin at the bottom end where it receives a ball end of the cable 35 in mechanical abutment therewith.

It will be readily understood by those of ordinary skill in the mechanical arts that the assembly of parts described above will function to resiliently captivate pin 13 within the assembly 10 such that the application of sufficient tension to cable 11 will cause the pin 13 to retract into retainer 15. It will be further understood that with the cable removed the sub-component 10 may be clinched into an apertured sheet as an assembled unit since the retainer cap 16 is in flush attachment with the top of retainer 15 so that a clinch force applied to the top of the retainer will be efficiently transmitted down through the sides of the retainer to the clinch structures 18 at the base of the retainer without damage to the internal structures of the assembly.

From the foregoing description of the preferred embodiment, it will be readily apparent that the objects of the invention to provide a spring pin assembly which can easily and permanently be joined to a sheet and which provides the advantage of removal and replacement of the actuating cable without the need for disassembly have been achieved. Various applications in which the present invention can be used include a remote release device for windows, doors, ladders, trunk lid release, etc. It may be used in single touch multiple release applications when several mechanisms are strung in parallel. The invention is particularly suited for use in restricted areas which are small spaces that limit manipulation. Other applications for the invention are limited only by the imagination since it is a simple mechanical device with many uses.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters patent of the United States is as follows:

1. A cable-operated retractable spring pin assembly, comprising:
a retainer having a barrel portion with a mouth at the top and fastening means at the bottom, said retainer further including a through-bore;
a pin in sliding engagement within said retainer barrel through-bore, said pin including a step on its exterior surface and a passage through the center of the pin extending the entire length thereof wherein said pin is selectively movable between retracted and extended positions;
a narrowed portion of the retainer through-bore having an internal stop that abuts the step of the pin when the pin is in the extended position;
an apertured cap affixed to the top of the retainer which captivates the pin within the retainer and provides for passage of a cable from the retainer through an aperture in the cap; and
a compression spring operatively positioned between an inside surface of the cap and the pin.

2. The device of claim 1 further including a cable having an enlarged portion at a distal end thereof, the cable extending through the passage in said pin, and the through-bore of the retainer.

3. The device of claim 2 wherein said pin includes an open mouth at the bottom including a recess for receiving the enlarged portion of the cable.

4. The device of claim 3 wherein said retainer through-bore includes an inner wall closely dimensioned to the outside diameter of the pin.

5. The device of claim 4 wherein said pin includes a counterbore which receives a portion of said spring.

6. The device of claim 5 wherein said end of said cable is in abutment with a downward-facing step in the passage of the pin at the bottom end.

7. The device of claim 6 wherein the enlarged portion at the end of said cable is substantially spherical.

8. The device of claim 1 wherein said retainer fastening means is clinch means.

9. The device of claim 1 wherein the apertured cap is clinched into the top of the retainer.

10. The device of claim 9 wherein the cap is in flush attachment with a top surface of the retainer.

11. The device of claim 2 wherein said spring is a coil spring that surrounds a portion of said cable within said retainer.

12. The device of claim 1 wherein the top of the pin is in abutment with the inside surface of the cap when the pin is in the retracted position.
